(19) United States
(12) Patent Application Publication
(10) Pub. No.: US 2019/0057180 A1
(43) Pub. Date: Feb. 21, 2019

(54) SYSTEM AND METHOD FOR DESIGN OPTIMIZATION USING AUGMENTED REALITY

(71) Applicant: INTERNATIONAL BUSINESS MACHINES CORPORATION, Armonk, NY (US)

(72) Inventors: Luis Angel D. Bathen, Placentia, CA (US); Simon-Pierre M. C. Genot, San Jose, CA (US); Rakesh Jain, San Jose, CA (US); Sunhwan Lee, Menlo Park, CA (US); Mu Qiao, Belmont, CA (US); Ramani R. Routray, San Jose, CA (US)

(21) Appl. No.: 15/680,369

(22) Filed: Aug. 18, 2017

(51) Int. Cl. G06F 17/50; G06T 19/00; G06T 19/20; G06F 3/01

(52) U.S. Cl. CPC G06F 17/5086; G06F 3/011; G06T 19/20; G06T 19/006

(57) ABSTRACT

Performing design optimization using an augmented reality system. Baseline data comprising baseline sensor data and baseline user input data is received by a computer system. An interactive baseline design optimization problem based on the baseline data is generated by the computer system. The baseline interactive optimization problem is transmitted by the computer system to the augmented reality system. Refined data comprising refined sensor data and refined user input data is received by the computer system. An interactive refined optimization problem based on the refined data and the baseline data is generated by the computer system. The interactive refined optimization problem is transmitted by the computer system to the augmented reality system.

### BACKGROUND

The present invention relates generally to the fields of augmented reality and design optimization, and more particularly to augmented reality design optimization systems and methods.

### SUMMARY

Embodiments of the present invention are directed to a method, system, and computer program product for performing design optimization using an augmented reality system. Baseline data comprising baseline sensor data and baseline user input data is received by a computer system from the augmented reality system. An interactive baseline design optimization problem based on the baseline data is generated by the computer system and transmitted to the augmented reality system for refinement. Refined data comprising refined sensor data and refined user input data is received by the computer system from the augmented reality system. An interactive refined optimization problem based on the refined data and the baseline data is generated by the computer system and transmitted to the augmented reality system for further refinement, as necessary.

### BRIEF DESCRIPTION OF THE DRAWINGS

The following detailed description, given by way of example and not intended to limit the invention solely thereto, will best be appreciated in conjunction with the accompanying drawings.

FIG. 1 is a functional block diagram depicting a design optimization system, in accordance with an embodiment of the present invention.

FIG. 2 is a flowchart illustrating operational steps of an aspect of the design optimization system as depicted in FIG. 1, in accordance with an embodiment of the present invention.

FIGS. 3A and 3B are schematic diagrams depicting an example implementation of the design optimization system in an environment, in accordance with an embodiment of the present invention.

FIG. 4 is a block diagram depicting a user computing device and/or an optimization management device of the design optimization system, in accordance with an embodiment of the present invention.

FIG. 5 depicts a cloud computing environment, in accordance with an embodiment of the present invention.

FIG. 6 depicts abstraction model layers, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the present invention are disclosed herein for purposes of describing and illustrating claimed structures and methods that may be embodied in various forms, and are not intended to be exhaustive in any way, or limited to the disclosed embodiments. Many modifications and variations will be apparent to those of ordinary skill in the art without departing from the scope and spirit of the disclosed embodiments. The terminology used herein was chosen to best explain the principles of the one or more embodiments, practical applications, or technical improvements over current technologies, or to enable those of ordinary skill in the art to understand the embodiments disclosed herein. As described, details of well-known features and techniques may be omitted to avoid unnecessarily obscuring the embodiments of the present invention.

References in the specification to “one embodiment”, “an embodiment”, “an example embodiment”, or the like, indicate that the embodiment described may include one or more particular features, structures, or characteristics, but it shall be understood that such particular features, structures, or characteristics may or may not be common to each and every disclosed embodiment of the present invention herein. Moreover, such phrases do not necessarily refer to any one particular embodiment per se. As such, when one or more particular features, structures, or characteristics is described in connection with an embodiment, it is submitted that it is within the knowledge of those skilled in the art to affect such one or more features, structures, or characteristics in connection with other embodiments, where applicable, whether or not explicitly described.

Optimization is one of the most widely studied topics in mathematics, computer science, and operations research, and finds application in a wide range of engineering and scientific fields. A design problem may be represented mathematically by a corresponding optimization problem or model, which may include an objective function. The objective function may be defined as a function of input variables and constraints, which may respectively represent design parameters and design conditions of the design problem. An optimal solution to the design problem may be represented by an optimized, or otherwise minimized or maximized value of the objective function. The minimized or maximized value may be determined by iteratively computing various values of the objective function, using various sets of the input variables. The input variables may otherwise be referred to as design variables in the context of optimization.

A value of the objective function may represent a particular solution to the corresponding design problem, which may be, for example, a design parameter of interest, such as one relating to cost, profit, weight, velocity, bandwidth, reliability, flow rate, temperature, applied pressure gradients, appearance, or a combination thereof. The input variables may represent the design parameters that may affect the design parameter of interest, and may be controllable from the point of view of a designer. The constraints may represent the design conditions that must be satisfied in order for the particular solution to be feasible. The constraints may relate to the design parameter of interest, and may limit the design parameters with respect to both magnitude and selection.

As may be appreciated by those of skill in the art, the design optimization process may be computationally demanding and time consuming, and is conventionally not conducted in real-time. It would be advantageous to be able to perform this process practically, in real-time. Augmented reality systems are being developed for application in a wide range of different fields, including, for example, gaming, military training, engineering, archaeology, architecture, therapy, marketing, exercise, music, and retail. An augmented reality system may use hardware and software to provide a direct or indirect view of a physical real-world environment, in which aspects of the view may be enhanced by digital data in real time. The digital data may include, for example, virtual objects representative of various types of information, such as various environmental conditions. The virtual objects may be based on sensory data collected by sensors in the environment and user inputs, among other things. For example, a particular “view” of a real-world environment may include visual aspects that may be modified with computer-generated imagery, auditory aspects that may be modified with computer-generated audio, and haptic aspects that may be modified with computer-generated tactile feedback. The various aspects are provided for purposes of example only, and are not intended to imply or suggest a particular limitation.

Embodiments of the present invention are directed to an augmented reality design optimization system and method that utilizes user inputs and sensory data collected from an environment to provide an interactive optimization problem. The interactive optimization problem may be used to represent a corresponding design problem that may be present in the environment, and may be based on information relating the environment, the design problem, the user inputs, and the sensory data. The interactive optimization problem may be displayed with respect to a direct or indirect view of the environment, and may be depicted by virtual objects overlaid onto aspects of the view. The interactive optimization problem may be manipulated by way of a user interface, in order to enable iterative specification of the interactive optimization problem in accordance with design goals of the user.

Embodiments of the present invention have the capacity to improve the technical field of augmented reality by enabling “user-friendly” and practical design optimization functionality in augmented reality systems.

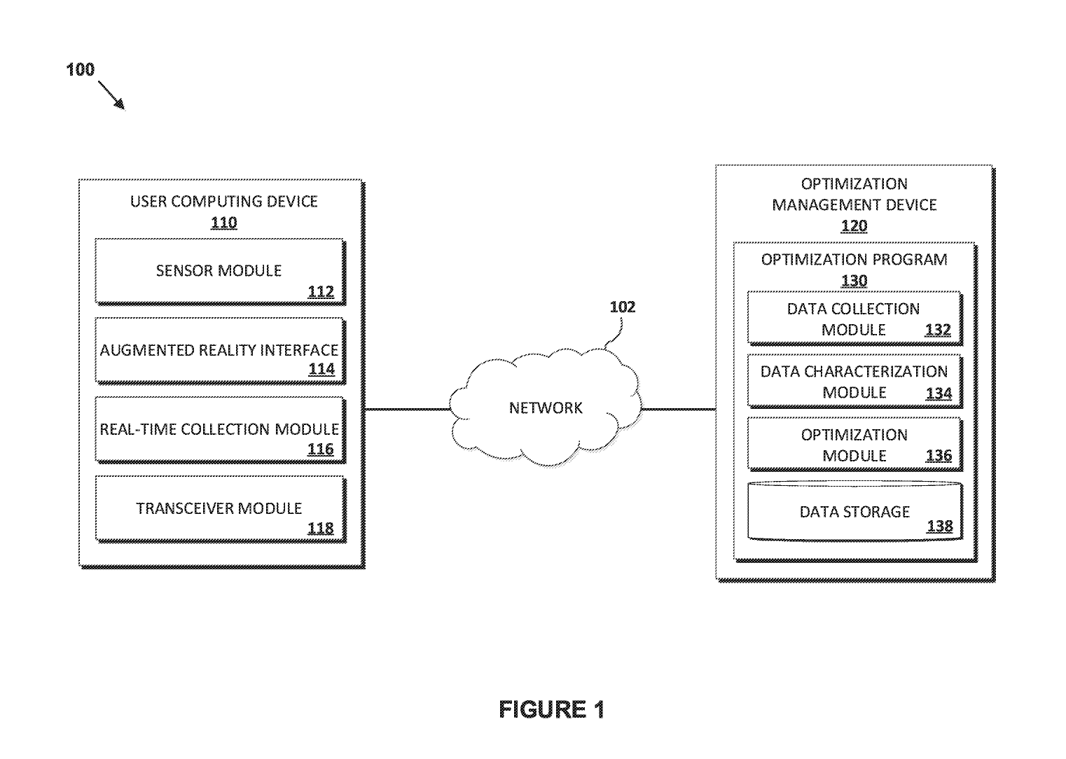

FIG. 1 is a functional block diagram depicting design optimization system 100, in accordance with an embodiment of the present invention. Design optimization system 100 includes user computing device 110 and optimization management device 120, interconnected over network 102.

In various embodiments of the present invention, network 102 represents an intranet, a local area network (LAN), or a wide area network (WAN) such as the Internet, and may include wired, wireless, or fiber optic connections. In general, network 102 may be any combination of connections and protocols that may support communications between user computing device 110 and optimization management device 120, in accordance with embodiments of the present invention. In the various embodiments, network 102 is the Internet, representing a worldwide collection of networks and gateways to support communications between devices connected to the Internet.

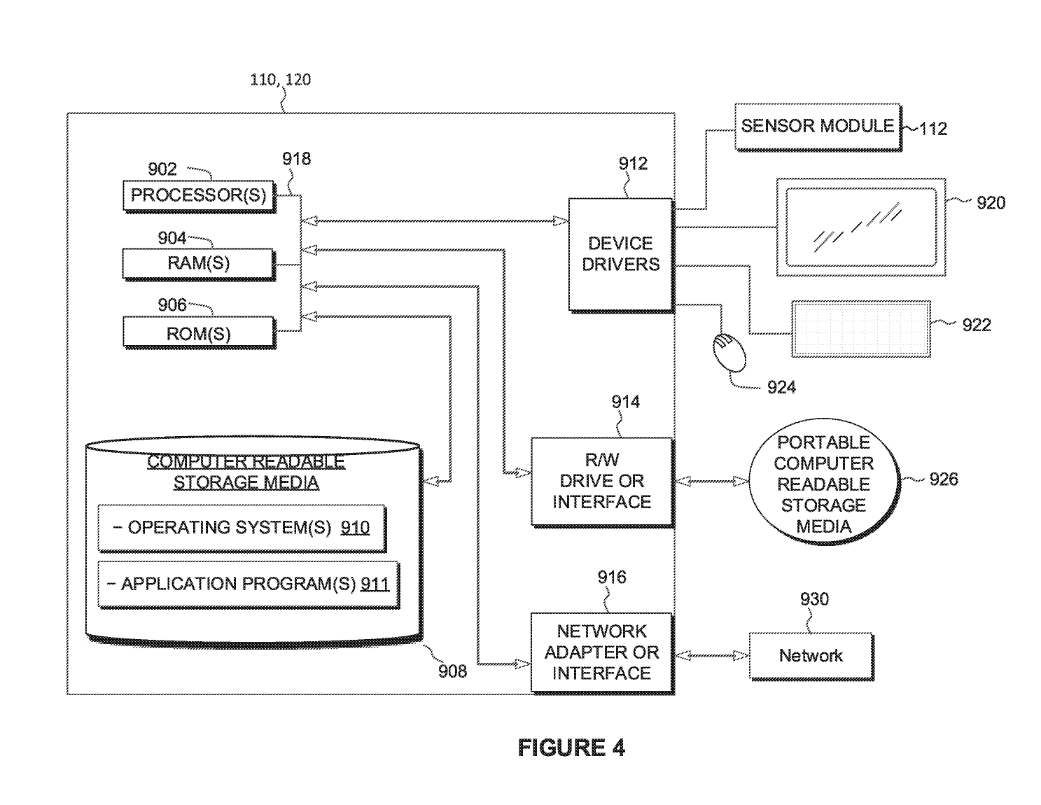

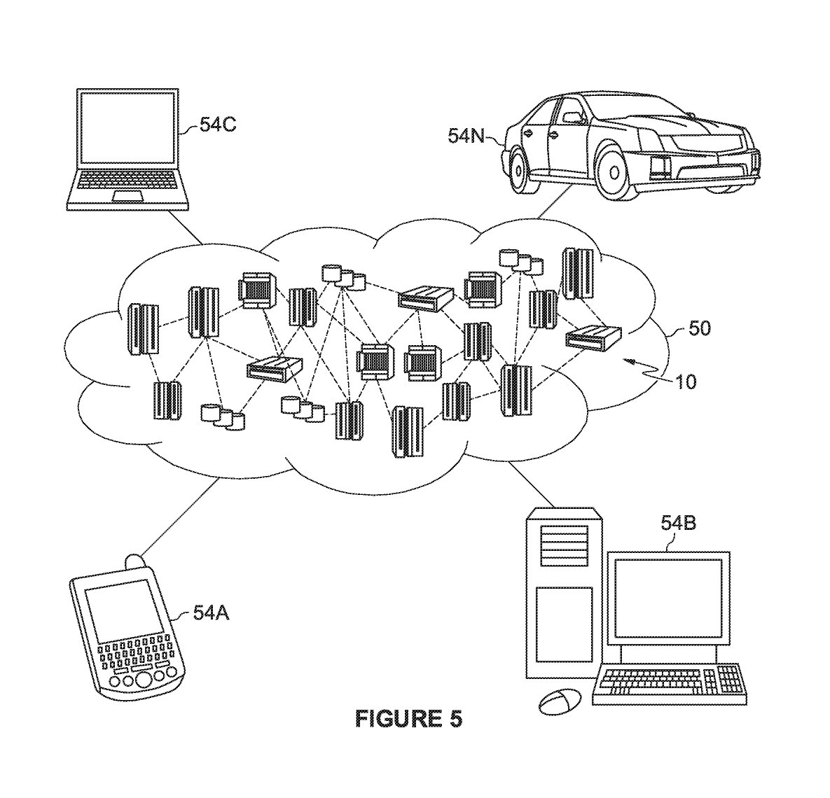

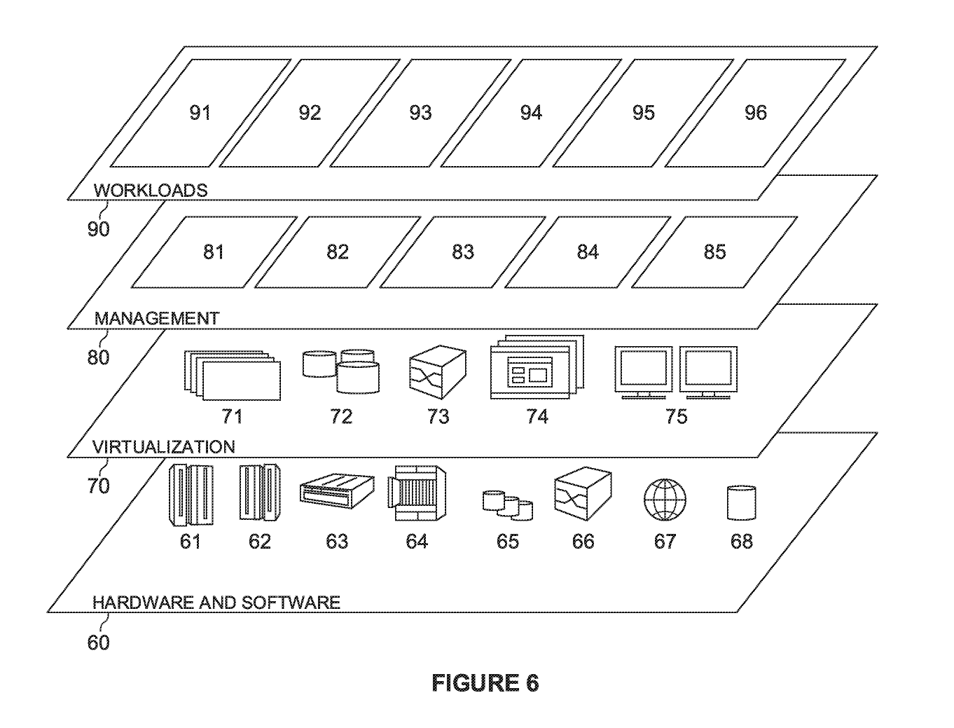

In various embodiments of the present invention, user computing device 110 and optimization management device 120 represent individual computing platforms such as a laptop computer, a desktop computer, or a computer server. In the various embodiments, user computing device 110 or optimization management device 120 may otherwise be any other type of computing platform, computing system, or information system capable of receiving and sending data to and from another device, by way of network 102. User computing device 110 or optimization management device 120 may include internal and external hardware components, as depicted and described with reference to FIG. 4. In other embodiments, user computing device 110 or interpretation management device 120 may be implemented in a cloud computing environment, as depicted and described with reference to FIGS. 5 and 6.

User computing device 110 includes sensor module 112, augmented reality interface 114, real-time collection module 116, and transceiver module 118. User computing device 110 may utilize hardware as discussed above, as well as a program, one or more subroutines contained in a program, an application programming interface, or the like, to support the cooperative operation of the modules and the interface, as well as to support communications between user computing device 110 and optimization program 130, residing on optimization management device 120.

Sensor module 112 represents sensors that may be used to obtain measurements of physical quantities to generate corresponding sensor data. The physical quantities may include, for example, those relating to fluid flow, power, temperature, pressure, and electromagnetic radiation. In various embodiments of the present invention, the sensors may be, for example, flow meters, voltage meters, temperature sensors, pressure sensors, and optical sensors. In the various embodiments, the sensors may otherwise be any device capable of obtaining measurements of the physical quantities, as such may exist in a physical environment. The sensors may be chosen according to factors related to the physical quantities, as such may relate to a particular design problem at-hand, and may be chosen as a matter of design choice.

Sensor module 112 may communicate the sensor data to the user computing device 110. In embodiments of the present invention, the sensor data may include physical measurement data, as well as metadata relating to associated times, positions, and orientations at which a corresponding instance of the physical measurement data was obtained. The sensor module 112 may implement stereoscopic computer vision and object recognition software and hardware. In various embodiments, user computing device 110 may receive some or all of the sensor data wirelessly. For example, the sensor module 112 may communicate with a wireless sensor network by way of corresponding gateway, which may include sensors spatially distributed throughout an environment.

Augmented reality interface 114 represents a user interface that may be used to interact with, alter, or otherwise manipulate an interactive optimization problem, as described in further detail below. The user interface may be, for example, any type of human-machine interface capable of enabling human-computer interaction, and receiving user input. Augmented reality interface 114 may utilize a display of the user computing device 110. Augmented reality interface 114 may otherwise utilize an auxiliary display of user computing device 110, such as in the form of a heads-up display, a head-mounted display, a helmet-mounted display, or the like. In embodiments of the present invention, the display may be utilized to display the interactive optimization problem, with respect to a direct or indirect view of an environment. In the embodiments, the interactive optimization problem may be depicted by, or may otherwise include, virtual objects overlaid onto the view of the environment. In an example, the indirect view may include a digital representation of the environment, which may include the virtual objects superimposed onto computer-generated imagery or video. In another example, the direct view may include the virtual objects superimposed onto portions of a transparent display.

In embodiments of the present invention, the virtual objects may be displayed in contextual association with aspects of the views to which they may relate. The aspects may include, for example, objects present in a particular view of an environment, as detected using computer vision and object recognition techniques. For example, a particular virtual object that may represent physical measurement data may be displayed to correspond to a detected source position of the physical measurement data, with respect to the particular view of the environment. In the embodiments, interacting with the interactive optimization problem may include, for example, manipulating, modifying, adjusting, altering, or otherwise controlling the virtual objects, by way of corresponding user inputs. The user input data may include design optimization operation data, representative of corresponding design optimization operations by the user. The design optimization operation data may be input to, or received by way of, augmented reality interface 114. The design optimization operation data may affect various aspects, conditions, or states of the virtual objects, including, for example, those relating to the sensor data, relative positioning, identifiers, relationships, and the like. For example, certain design optimization operations may result in a selection of a particular type of physical measurement data, or changes to the physical measurement data, as represented by a corresponding virtual object. Other design optimization operations may result in changes to relative positions of selected virtual objects with respect to, for example, aspects of a corresponding view of an environment or other virtual objects. Certain other design optimization operations may result in changes to identifiers of specific virtual objects, such as with respect to designations of data of interest including certain of the specific virtual objects. Various other design optimization operations may result in changes to relationships of various virtual objects with respect to, for example, aspects of a corresponding view of an environment or other virtual objects. Conceivably, other types of design optimization operations may also be implemented, and may be chosen as a matter of design choice.

Real time collection module 116 represents functionality of user computing device 110 that operates to receive and associate the sensor data, user input data, and the virtual objects in accordance with interactions of the user with the interactive optimization problem. In various embodiments of the present invention, real time collection module 116 may also receive other data for respective association with the sensor data, the user input data, or the virtual objects. The other data may include, for example, GPS data, weather data, and any other data that may be applied in providing the interactive optimization problem, in accordance with embodiments of the present invention. For example, the other data may include certain types of user input data that may require natural language processing to determine corresponding design optimization operations. Conceivably, other types of data may also be received and associated, and may be chosen as a matter of design choice.

Transceiver module 118 represents functionality of user computing device 110 that operates to transmit and receive optimization data to and from optimization management device 120, by way of network 102. The optimization data may include the sensor data and the user input data.

Optimization management device 120 may utilize hardware as discussed above to host optimization program 130. Optimization program 130 includes data collection module 132, data characterization module 134, optimization module 136, and data storage 138. Optimization program 130 represents a program, one or more subroutines contained in a program, an application programming interface, or the like, that operates to receive data from user computing device 110, to generate and provide a corresponding interactive optimization problem. The corresponding interactive optimization problem may be displayed by user computing device 110.

Data collection module 132 represents functionality of optimization program 130 that communicates with transceiver module 118 to receive the optimization data. Data collection module 132 stores the received optimization data for later retrieval in data storage 138, in the form of, for example, separate computer-readable data files.

Data characterization module 134 represents functionality of optimization program 130 that receives the optimization data for characterization, to subsequently generate the interactive optimization problem. Data characterization module 134 characterizes the received optimization data by detecting patterns in the sensor data, to identify relationships present amongst sets of the data. The identified relationships may be used to define objective functions of the interactive optimization problem, in terms of corresponding input variables and constraints. The interactive optimization problem may be used to represent a corresponding design problem, in terms of design parameters and design conditions.

In various embodiments of the present invention, data characterization module 134 may utilize data reduction, data-mining, or data clustering algorithms, either individually or in combination, to detect the patterns. The data-mining algorithms may include, for example, clustering algorithms such as statistical clustering algorithms, including mode association clustering algorithms, mixture-model clustering algorithms, k-means clustering algorithms, k-center clustering algorithms, linkage clustering algorithms, and spectral graph partitioning clustering algorithms. In the various embodiments, data characterization module 134 may also utilize data classification algorithms, either individually or in combination, to identify the relationships based on the detected patterns. The classification algorithms may include, for example, decision tree algorithms, exploratory factor analysis algorithms, principal component analysis algorithms, maximum likelihood estimation algorithms, deep feature synthesis algorithms, algorithms based on neural networks, support vector machines, and random forest. The appropriate choice of the data-mining algorithms and the data classification algorithms may depend upon factors related to a particular design problem at-hand, and may be chosen as a matter of design choice.

The data-mining algorithms may be used to identify, relate, and associate sets of the sensor data to generate corresponding data clusters. The classification algorithms may subsequently be used to, for example, classify the generated data clusters in terms of objective functions and corresponding input variables and constraints. In various embodiments of the present invention, a corresponding interactive optimization problem may subsequently be generated based on the objective functions and corresponding input variables and constraints. The interactive optimization problem may be generated in the form of an interactive visualization of interdependencies between design parameters and design conditions, based on the generated and classified data clusters. The classified data clusters may correspond to design problems and associated design parameters and design conditions.

In various embodiments of the present invention, the optimization data may include baseline optimization data and refined optimization data, which may be used to respectively provide a baseline interactive optimization problem and a refined interactive optimization problem. The baseline optimization data may include baseline sensor data and baseline user input data, which may be used to characterize the baseline interactive optimization problem in terms of corresponding baseline objective functions. The refined optimization data may include refined sensor data and refined user input data which may be used to characterize the refined interactive optimization problem in terms of corresponding refined objective functions, with respect to the baseline interactive optimization problem. In the various embodiments, the refined interactive optimization problem represents the product of iterative specification of the baseline interactive optimization problem, in accordance with the design goals of the user. The iterative specification may be based on design optimization operations relating to refinements which may be implemented with respect to the objective functions, and corresponding input variables and constraints, used in defining the baseline objective functions. For example, the design optimization operations relating to the refinements may designate data of interest with respect to the input variables and the constraints used in defining the baseline objective functions. The data of interest may include, for example, specified input variables and constraints of the baseline objective functions to include in a subsequently provided refined interactive optimization problem. The data of interest may otherwise include, for example, other input variables and constraints.

In various embodiments of the present invention, the interactive optimization problem may include a trade space. The trade space may be implemented by the user in identifying and analyzing the relationships between design parameters and design conditions of a design problem, during the iterative specification of the baseline interactive optimization problem. More particularly, the trade space may represent relationships between objective functions, corresponding sets of input variables, and corresponding sets of constraints. The trade space may be based on the detected patterns in the sensor data, and the identified relationships amongst sets of the data. For example, the trade space may depict various sets of related objective functions, input variables, and constraints. The trade space may also depict values of a particular objective function, as a function of: values of particular input variables, and values of particular constraints. In the various embodiments, the trade space may be implemented by the user to identify and analyze the relationships between objective functions, corresponding sets of input variables, and corresponding sets of constraints. The relationships may represent corresponding relationships between design parameters and design conditions of a design problem. For example, the user may explore or navigate the trade space, by way of augmented reality interface 114, to identify related design parameters and design conditions. The user may subsequently, for example, analyze the related design parameters and design conditions, with respect to levels of interdependencies between various sets of the related design parameters and design conditions. In various embodiments of the present invention, the trade space may be interactive, and may be implemented by way of augmented reality interface 114. In the various embodiments, the trade space may be depicted by, or may otherwise include, one or more virtual objects overlaid onto the view of the environment.

The trade space may take the form of, for example, graphs such as decision trees, scatter plots, and bar graphs. The trade space may include control tools, such as in the form of virtual knobs, sliders, and dials. For example, the relationships may be depicted by corresponding graphs, in which the values of the objective function may be mapped to corresponding sets of input variables and constraints. Particular input variables or constraints of interest may be selected by way of corresponding design optimization operations for further analysis, or for use in, for example, the refined interactive optimization problem. The control tools may be manipulated by the user to, for example, vary values of particular input variables and constraints of the sets of input variables and constraints, and to select data of interest. The user may, for example, select particular sets of input variables, and vary values of particular input variables forming the sets, to analyze the relationships by observing resulting values of the corresponding objective functions. Additionally, the user may, for example, use the control tools to change the applied data-mining and data classification algorithms. Further, the user may, for example, modify the decision trees to, for example, analyze relationships between various sets of data, specify alternative data clustering algorithms or data classification algorithms to be used, and so on. The manipulations may be affected by augmented reality interface 114, by way of corresponding design optimization operations. Many other forms of the manipulations are conceivable, and may be chosen as a matter of design choice.

Optimization module 136 represents functionality of optimization program 130 that receives generated interactive optimization problems for optimization. Optimization module 136 may continuously retrieve sets of the stored computer-readable data files during optimization. In various embodiments of the present invention, optimization module 136 optimizes the received interactive optimization problem by solving the corresponding objective functions. In the various embodiments, optimization program 130 may seek to determine a maximum or minimum value for each of the objective functions, by iteratively computing values of the objective functions. Optimization module 136 may solve the objective functions by iteratively computing the values, by using various combinations of corresponding input variables and constraints, and by varying values of the input variables or constraints forming the combinations, during the optimization.

Data storage 138 represents functionality of the optimization program 130 that receives and stores the optimization data, for retrieval and use by optimization program 130.

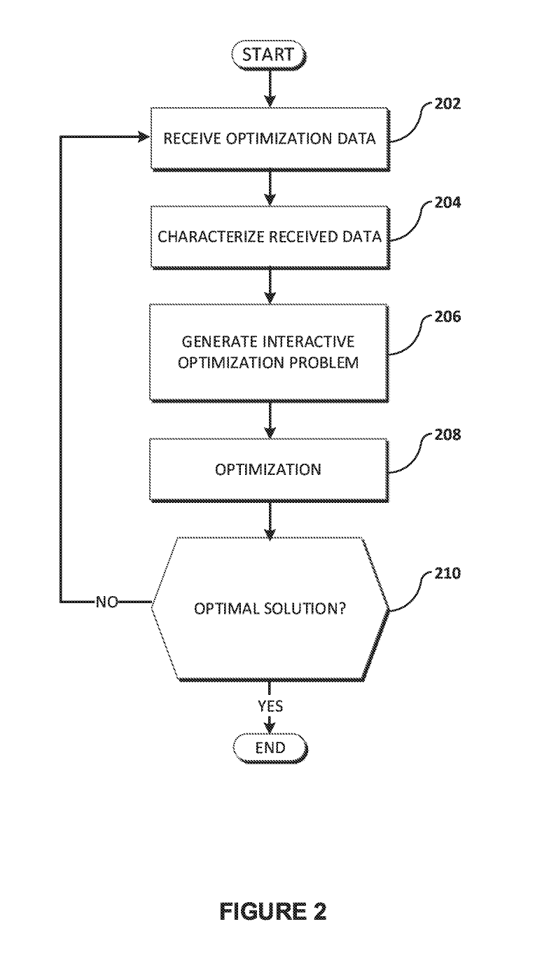

FIG. 2 is a flowchart illustrating operational steps of an aspect of design optimization system 200 as depicted in FIG. 1, in accordance with an embodiment of the present invention.

At step 202, data collection module 132 of optimization program 130, residing on optimization management device 120, receives the optimization data for storage and later use. Data collection module 132 may index the received optimization data with respect to corresponding interactive optimization problems.

At step 204, data characterization module 134 receives the optimization data for characterization. The received optimization data may include baseline optimization data and refined optimization data. The baseline optimization data represents an initial representation of a design problem. The refined optimization data represents a refined representation of the design problem, in accordance with the design goals of the user.

At step 206, data characterization module 134 receives the characterized data, and subsequently generates the interactive optimization problem based on the characterized data. The interactive optimization problem may include a corresponding trade space. Data characterization module 134 may generate a baseline interactive optimization problem and a refined interactive optimization problem. The baseline interactive optimization problem may be generated to provide the initial representation of the design problem. The baseline interactive optimization problem may be refined to produce the refined interactive optimization problem. The refined interactive optimization problem may be generated to provide the refined representation of the design problem, in accordance with the design goals of the user.

At step 208, optimization module 136 receives the generated interactive optimization problem. Optimization module 136 repeatedly solves each of the objective functions of the interactive optimization problem, to determine a maximum or minimum value for each of the objective functions. In solving each of the objective functions, optimization module 136 may iteratively compute values of each of the objective functions, as a function of various combinations of corresponding input variables and constraints. Optimization module 136 also varies values of the input variables or constraints forming the combinations in determining the maximum or minimum values. In various embodiments of the present invention, optimization module 136 may optimize baseline interactive optimization problems and refined interactive optimization problems. In the various embodiments, the refined interactive optimization problems may differ from the baseline interactive optimization problems with respect to, for example, respective objective functions. The refined objective functions may include corresponding input variables and constraints that may differ from those of the baseline objective functions. Further, the refined objective functions may include, for example, assigned weights with respect to the input variables or the constraints. Conceivably, other refinements may also be implemented, based on the particular design problem at-hand, and may be chosen as a matter of design choice.

At step 210, if data collection module 132 receives refined optimization data corresponding to the baseline optimization data, steps 202, 204, 206, and 208 may be repeated, as previously described. This process may continue until data collection module 132 receives optimization data indicating that an optimal solution was identified by the user, in accordance with the design goals.

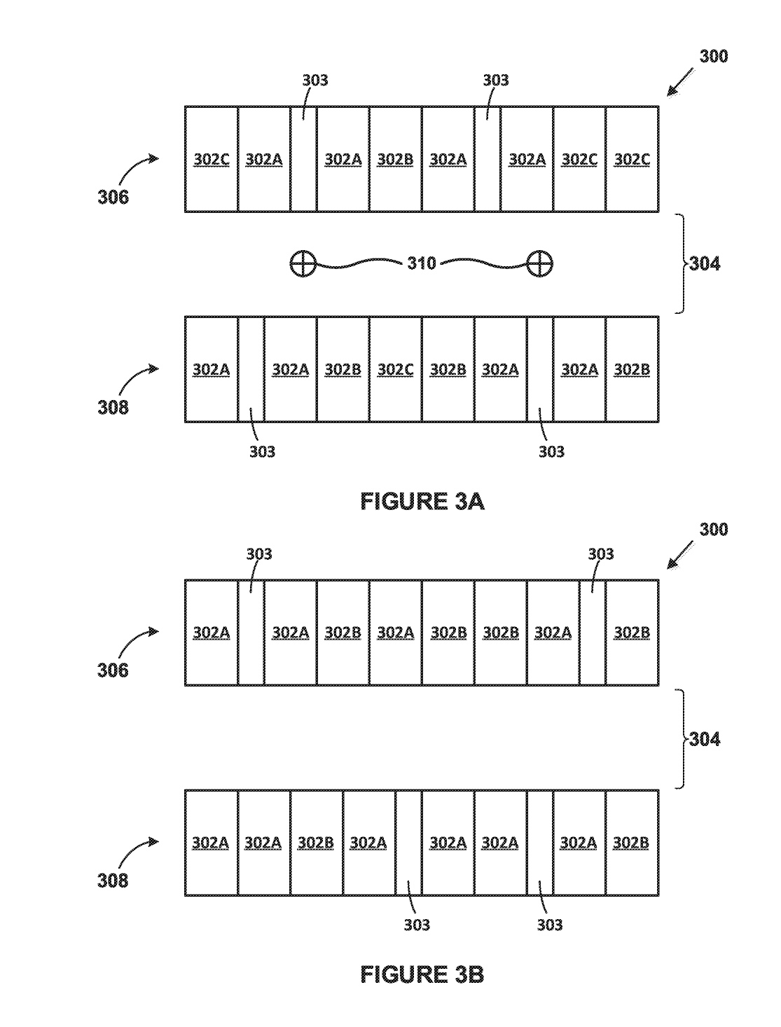

FIGS. 3A and 3B are schematic diagrams depicting an example implementation of design optimization system 100 in environment 300, in accordance with an embodiment of the present invention. Environment 300 may be a three dimensional space in which racks 302A-C and coolers 303 may be relatively positioned and arranged in a layout formed of rows 306 and 308, which may be separated by aisle 304. Data collection points 310 represent positions in environment 300 from which the sensor data may be collected. For purposes of the present disclosure, either or both of rows 306 and 308 may represent a respective cluster of racks 302. The number, positioning, and arrangement of racks constituting a “cluster of racks” may be determined as a matter of design choice.

Environment 300 represents, for example, a data center environment which may provide data hosting services for Internet service providers, application service providers, Internet content providers. The data center environment may include cooling air distribution plenums, undepicted, to distribute cooling air to portions of the environment, and hot air collection plenums, undepicted, to collect hot air from other portions of the environment. For example, the cooling air may be distributed to portions of the environment about coolers 303 and adjacent racks 302, and the hot air may be collected from aisle 304, for cooling and redistribution. For purposes of the present disclosure, environment 300 has been depicted two-dimensionally; in practice, the environment 300 may be a three-dimensional space.

Each of racks 302 represent, for example, enclosures for housing the equipment. Racks 302 may support the operation of the equipment by, for example, facilitating the distribution of power to the equipment, which may be consumed and partially converted to heat. Generally, power consumption by the equipment housed in each of racks 302 (“rack power”) may range, for example, between approximately 1 kW to 25 kW. Coolers 303 may also support the operation of the equipment by facilitating proper climate control, or proper environmental operating conditions, within each of racks 302. For example, each of racks 302 may include heat exchanging systems in fluid communication with the cooling air distribution plenums and the hot air collection plenums, to receive the cooling air and to exhaust the hot air, respectively. The heat exchanging systems may include corresponding cooling air inlets and hot air outlets for such purposes. The cooling air inlets may be in fluid communication with, for example, local cooling units, such as coolers 303, and the hot air outlets may be in fluid communication with, for example, return vents present in aisle 304. The heat exchanging systems may include, for example, various sensors and metering devices such as thermal sensors, air flow meters, power meters, for use in supporting and controlling the proper environmental operating conditions.

Data collection points 310 represent positions in environment 300 from which sensor data may be collected. The positions may be represented by corresponding metadata associated with the sensor data. The sensor data may be collected by way of sensor module 212. In various embodiments of the present invention, sensor module 212 may receive the sensor data wirelessly, from sensors of the wireless sensor network, as previously described. The sensors of the wireless sensor network may be formed, for example, by the sensors and metering devices of the heat exchanging systems of racks 302. An adequate number and positioning of data collection points 310 may depend upon factors relating to a particular design problem at-hand, and may be chosen as a matter of design choice. For example, the adequate number and positioning may be determined heuristically. Data collection points 310 are illustrated to be representative of example positions in environment 300 from which sensory data can be collected, and are not intended to imply or suggest a particular limitation as to a number or positioning thereof.

A common data center design goal, such as with respect to the environment 300, may relate to optimizing cooling performance of racks 302. The design goal may be met by determining an optimal layout of racks 302. The optimal layout may facilitate and maximize the ingestion of distributed cooling air, as well as the collection of exhausted hot air, to minimize net heating of environment 300.

The capture index is a cooling performance metric that can be used to measure levels of cooling performance of each of racks 302. The capture index can be determined based on airflow characteristics associated with cooling air distributed to a rack, or hot air collected from the rack. The capture index can take the form of a cold air capture index, based on the fraction of ingested cooling air by a rack that is distributed to the rack. Alternatively, the capture index can take the form of a hot air capture index, based on the fraction of exhausted hot air by a rack that is collected from the rack. For example, the cooling air that is ingested can be distributed by local coolers such as the coolers 303, and the hot air that is exhausted can be collected by return vents, as such may be present in the aisle 304. The capture index may range in value between 0% and 100%, with higher values generally indicative of better cooling performance.

Total escaped power is another cooling performance metric that can be used to measure levels of cooling performance of a particular cluster of racks 302. The total escaped power is based on the capture index and the rack power for each rack of a cluster of racks. For example, for the particular cluster of racks 302, the total escaped power can be based on the capture index and the rack power for each rack 302 of the particular cluster of racks 302. The total escaped power may be computed according to the equation:

$${\sum }_{i = 1}^{n} ( 1 - {CI}_{i} ) {P}_{i}$$

where CI and P are the capture index and the rack power, respectively, for a single rack i.

With reference to FIG. 3A, an initial layout of cluster of racks 302 is depicted. The initial layout may result in, for example, various capture index values including good, intermediate, and bad capture index values of racks 302A, 302B, and 302C, respectively. The various capture index values may be caused by various individual rack power and cooling requirements across the cluster. In an embodiment of the present invention, the initial layout of racks 302 in environment 300 may represent a design problem for which a corresponding optimization problem may be generated.

The design problem may be defined, for example, with respect to design conditions and design parameters relating to cooling performance metrics such as the capture index and the total escaped power, which may sought to be minimized. Accordingly, related design parameters may include, for example, those relating to a layout of racks 302, airflow characteristics relating to each of racks 302, and the rack power of each of racks 302. The design conditions may include, for example, those relating to the requirement that the capture index of each of racks 302 remain equal to or greater than 80%. A design goal may relate to minimization of the total escaped power of each of racks 302, with respect to a cluster of racks 302. In an embodiment of the present invention, an interactive optimization problem corresponding to the design problem may allow for interaction and iterative specification of the interactive optimization problem, using augmented reality interface 114. The interactive optimization problem may be used to determine an optimal layout of racks 302 that may optimize the total escaped power of cluster of racks 302. The interactive optimization problem may include virtual objects that represent corresponding objective functions and values thereof. The virtual objects may represent, for example, the total escaped power of cluster of racks 302. The interactive optimization problem may include virtual objects representative of corresponding input variables, which may include, for example, those relating to the layout of racks 302, the airflow characteristics, and the rack power with respect to each rack 302 of a cluster of racks 302. In some instances, the input variables may also include, for example, those relating to relative positions of each of racks 302 and coolers 303 and characteristics relating to environment 300. The interactive optimization problem may include virtual objects representative of corresponding constraints, which may include, for example, those relating to the requirement that the capture index of each of racks 302 remain equal to or greater than 80%.

For example, the baseline interactive optimization problem may include virtual objects representative of the layout of racks 302, the airflow characteristics, and the rack power with respect to each rack 302 of a cluster of racks 302. The refined interactive optimization problem may include, for example, additional virtual objects, which may be representative of relative positions of each of racks 302 and coolers 303, other characteristics relating to environment 300, as well as other related design parameters or design conditions. In the embodiment, the additional virtual objects may be identified and specified by corresponding design optimization operations, input by way of augmented reality interface 114. The design optimization operations may affect a trade space of the interactive optimization problem. The trade space may include graphs that may be associated with other of the graphs to represent relationships between the total escaped power and the corresponding design parameters and design conditions. For example, the additional virtual objects may be identified and specified using one or more decision trees of the trade space. The interactive optimization problem may otherwise be defined differently, where other types of analyses, based on other types of metrics, may be used. The metrics may include, for example, a supply heat index or a return heat index, a rack cooling index, and a recirculation index. The interactive optimization problem may generally be defined based on factors relating to the design problem at hand, and may be generated according design choice.

With reference to FIG. 3B, the optimal layout of the cluster of racks 302 is depicted. The optimal layout may better accommodate the various individual rack power and cooling requirements of each of racks 302, resulting in the elimination of bad capture index values across cluster of racks 302. For purposes of the present disclosure, the optimal layout illustrates an example solution to the design problem, and is not intended to imply or suggest a particular limitation.

In an alternative embodiment of the present invention, environment 300 represents, for example, a surrounding environment of an aircraft wing. A design goal may relate to determining an optimal size and shape of the aircraft wing. Accordingly, a corresponding design problem may be defined in terms of design parameters relating to a plan view layout of the wing. The design parameters may include, for example, those relating to a semi-span size of the wing, an aspect ratio of the wing, a quarter chord sweep angle of the wing, a taper ratio of the wing, a sparbox root chord of the wing, and a rotary fan diameter size. The design conditions may include, for example, those relating to limitations with respect to cost, range, buffet altitude, and takeoff field length. In the alternative embodiment, an interactive optimization problem corresponding to the design problem may allow for interaction and iterative specification of the interactive optimization problem, using augmented reality interface 114. The interactive optimization problem may be used to determine an optimal size and shape of the aircraft wing that may optimize, for example, the cost and the range. The interactive optimization problem may rely on various aerodynamic analyses and metrics in defining corresponding objective functions, input variables, and constraints. The interactive optimization problem may include virtual objects representative of the input variables, relating to, for example, design parameters including the semi-span size of the wing, the aspect ratio of the wing, the quarter chord sweep angle of the wing, the taper ratio of the wing, the sparbox root chord of the wing, and the rotary fan diameter size. The interactive optimization problem may include virtual objects representative of the corresponding objective functions and values thereof, relating to, for example, one or more of the limitations, which may be minimized or maximized, accordingly. The interactive optimization problem may include virtual objects representative of the constraints, which may relate to, and impose certain requirements with respect to, for example, the limitations.

For example, the interactive optimization problem may include a baseline interactive optimization problem, which may include corresponding input variables and constraints corresponding to only a portion of the design parameters and the design conditions, respectively. Similar to above, a corresponding refined interactive optimization problem of the interactive optimization problem may include, for example, additional virtual objects. In the alternative embodiment, the additional virtual objects may be identified and specified by corresponding design optimization operations, input by way of augmented reality interface 114. For example, the design optimization operations may be used to develop or further define decision trees of a trade space of the interactive optimization problem. The interactive optimization problem may otherwise be defined differently, where other types of analyses, based on other types of metrics, may be chosen and used as a matter of design choice. The objective functions may be solved by, for example, iteratively computing the values of the objective functions as a function of the constraints, using various values of the input variables, to optimize the values of the objective functions.

As may be appreciated by those of skill in the art, various other embodiments of the present invention are conceivable, in which design problems may be represented by corresponding optimization problems, where corresponding objective functions, sets of input variables, and sets of constraints of the optimization problems may be defined with respect to the design problems, accordingly.

FIG. 4 is a block diagram depicting user computing device 110 and/or optimization management device 120 of design optimization system 100, in accordance with an embodiment of the present invention.

As depicted in FIG. 4, user computing device 110 and/or optimization management device 120 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as optimization program 130 residing on optimization management device 120, as depicted in FIG. 1, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

User computing device 110 and/or optimization management device 120 may also include a R/W drive or interface 914 to read from and write to one or more portable computer readable storage media 926. Application programs 911 on user computing device 110 and/or optimization management device 120 may be stored on one or more of the portable computer readable storage media 926, read via the respective R/W drive or interface 914 and loaded into the respective computer readable storage media 908. User computing device 110 and/or optimization management device 120 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the server 220 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers. User computing device 110 and/or optimization management device 120 may also include a display screen 920, a keyboard or keypad 922, and a computer mouse or touchpad 924. In embodiments of the present invention, user computing device 110 may also include the sensor module 212. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may include hardware and software (stored on computer readable storage media 908 and/or ROM 906).

Optimization management device 120 can be a standalone network server, or represent functionality integrated into one or more network systems. In general, user computing device 110 and/or optimization management device 120 can be a laptop computer, desktop computer, specialized computer server, or any other computer system known in the art. In certain embodiments, optimization management device 120 represents computer systems utilizing clustered computers and components to act as a single pool of seamless resources when accessed through a network, such as a LAN, WAN, or a combination of the two. This implementation may be preferred for data centers and for cloud computing applications. In general, user computing device 110 and/or optimization management device 120 can be any programmable electronic device, or can be any combination of such devices.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and optimization 96.

Optimization 96 may include functionality enabling the cloud computing environment to be used to receive sensor data and user input data relating to a design problem, to generate a corresponding interactive optimization problem for optimization of the design problem by way of an augmented reality system.

While the invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the present invention has been disclosed by way of example for purposes of illustration, and not limitation.

1. A method of performing design optimization using an augmented reality system, the method comprising:
receiving, by a computer system from an augmented reality device, baseline sensor data of an environment and baseline design constraints;
generating, by the computer system, an interactive baseline design optimization problem that optimizes a design parameter of interest based on the baseline sensor data and the baseline design constraints;
solving, by the computer system, the interactive baseline design optimization problem; and
transmitting, by the computer system to the augmented reality device, the solved interactive baseline design optimization problem.

2. The method of claim 1, further comprising:
receiving, by the computer system from the augmented reality device, refined sensor data of the environment and refined design constraints;
generating, by the computer system, an interactive refined design optimization problem based on the refined sensor data and the refined design constraints;
solving, by the computer system, the interactive refined design optimization problem; and
transmitting, by the computer system to the augmented reality device, the solved interactive refined design optimization problem.

3. The method of claim 2, wherein the refined sensor data and the refined design constraints are weighted.

4. The method of claim 1, wherein the interactive baseline design optimization problem optimizes at least one of the design parameters of interest selected from a group comprising cost, profit, weight, velocity, bandwidth, reliability, flow rate, temperature, applied pressure gradient, and appearance.

5. The method of claim 1, wherein the interactive baseline design optimization problem implements a trade space comprising visualizations of relationships between the design constraints and the baseline sensor data.

6. The method of claim 1, wherein the interactive baseline design optimization problem minimizes the design parameter of interest of a data center, and wherein the design parameter of interest is at least one of cooling performance, capture index, and total escaped.

7. A computer system for performing design optimization using an augmented reality system, the computer system comprising:
one or more computer processors, one or more computer-readable storage media, and program instructions stored on one or more of the computer-readable storage media for execution by at least one of the one or more processors, the program instructions, when executed by the at least one of the one or more processors, causing the computer system to perform a method comprising:
receiving, from an augmented reality device, baseline sensor data of an environment and baseline design constraints;
generating an interactive baseline design optimization problem that optimizes a design parameter of interest based on the baseline sensor data and the baseline design constraints;
solving the interactive baseline design optimization problem; and
transmitting, to the augmented reality device, the solved interactive baseline design optimization problem.

8. The computer system of claim 7, further comprising:
receiving, from the augmented reality device, refined sensor data of the environment and refined design constraints;
generating an interactive refined design optimization problem based on the refined sensor data and the refined design constraints;
solving the interactive refined design optimization problem; and
transmitting, to the augmented reality device, the solved interactive refined design optimization problem.

9. The computer system of claim 8, wherein the refined sensor data and the refined design constraints are weighted.

10. The computer system of claim 7, wherein the interactive baseline design optimization problem optimizes at least one of the design parameters of interest selected from a group comprising cost, profit, weight, velocity, bandwidth, reliability, flow rate, temperature, applied pressure gradient, and appearance.

11. The computer system of claim 7, wherein the interactive baseline design optimization problem implements a trade space comprising visualizations of relationships between the design constraints and the baseline sensor data.

12. The computer system of claim 7, wherein the interactive baseline design optimization problem minimizes the design parameter of interest of a data center, and wherein the design parameter of interest is at least one of cooling performance, capture index, and total escaped.

13. A computer program product for performing design optimization using an augmented reality system, the computer program product comprising:
one or more computer-readable storage devices and program instructions stored on at least one of the one or more computer-readable storage devices, the program instructions, when executed by the at least one processor, causing a computer system to perform a method comprising:
receiving from an augmented reality device, baseline sensor data of an environment and baseline design constraints;
generating an interactive baseline design optimization problem that optimizes a design parameter of interest based on the baseline sensor data and the baseline design constraints;
solving the interactive baseline design optimization problem; and
transmitting, to the augmented reality device, the solved interactive baseline design optimization problem.

14. The computer program product of claim 13, further comprising:
receiving, from the augmented reality device, refined sensor data of the environment and refined design constraints;
generating an interactive refined design optimization problem based on the refined sensor data and the refined design constraints;
solving the interactive refined design optimization problem; and
transmitting, to the augmented reality device, the solved interactive refined design optimization problem.

15. The computer program product of claim 14, wherein the refined sensor data and the refined design constraints are weighted.

16. The computer program product of claim 13, wherein the interactive baseline design optimization problem optimizes at least one of the design parameters of interest selected from a group comprising cost, profit, weight, velocity, bandwidth, reliability, flow rate, temperature, applied pressure gradient, and appearance.

17. The computer program product of claim 13, wherein the interactive baseline design optimization problem implements a trade space comprising visualizations of relationships between the design constraints and the baseline sensor data.

18. The computer program product of claim 13, wherein the interactive baseline design optimization problem minimizes the design parameter of interest of a data center, and wherein the design parameter of interest is at least one of cooling performance, capture index, and total escaped.
